(19) United States
(12) Patent Application Publication
(10) Pub. No.: US 2014/0116642 A1
(43) Pub. Date: May 1, 2014

(54) Battery-Operated Auxiliary Power Unit

(71) Applicant: Grant Courtney, Brandon, MS (US)

(72) Inventor: Grant Courtney, Brandon, MS (US)

(21) Appl. No.: 13/661,051

(22) Filed: Oct. 26, 2012

(51) Int. Cl. B60H 1/00

(52) U.S. Cl. CPC B60H 1/00007
USPC 165/42; 29/592.1

(57) ABSTRACT

The invention is a Battery-Operated Auxiliary Power Unit that adds an independent supplementary heating and air conditioning system to a truck's sleeping quarters that is capable of controlling the temperature of the sleeper compartment during the off period without running his truck motor and creating needless pollution.

### CROSS-REFERENCES TO RELATED APPLICATIONS

None.

### STATEMENT REGARDING FEDERALLY SPONSORED RESEARCH AND DEVELOPMENT

None.

### THE NAMES OF THE PARTIES TO A JOINT RESEARCH AGREEMENT

None.

### INCORPORATION-BY-REFERENCE OF MATERIAL SUBMITTED ON A COMPACT DISC

None.

### BACKGROUND OF THE INVENTION

1. Field of the Invention

Vehicle-mounted tractor cab-heating systems.

2. Background Art

Truck drivers taking loads over long distances often sleep in their truck's sleeper compartment during their off period. The trucks employ one heating and cooling system to control the temperature in the front cabin where the driver sits, and an entirely different system for the sleeping compartment, or “sleeper” section. Both of these systems are powered by the trucks diesel engine.

Semi-trucks typically have four 12V batteries to run all electrical systems and crank the truck's diesel engine. While the truck's engine is operating, trucks have an alternator (typically around 130 A) that keeps the batteries charged, and provides sufficient power for operation of all the trucks electric systems. However, federal law prohibits commercial truck operators from driving longer than eleven hours out of a 24 14-hour period and then they must have a 10-hour off period, of which 8 hours must be spent inside the sleeper compartment. During the off-period the operator must get sleep and have somewhere to spend their time. The only way for the trucker to power the heat and air conditioning systems of a stock truck is to run the diesel drive motor.

However, running the diesel drive motor all night has severe repercussions. Truck motors consume about a gallon of diesel fuel per hour to idle at night in order to keep the sleeper compartment warm in cold weather by circulating antifreeze through the heater core. A blower fan circulates the air through the trucks sleeper compartment's ductwork. In order to keep the cabin cool in hot weather, operators must run the diesel drive motor to power the air conditioning system. Idling the drive motor during these prolonged periods is uneconomical, as it shortens the life of the motor and costs upwards of $40.00 per day (assuming $4.00 per gallon and a 10-hour off-period, in 2012 pricing).

With today's focus on environmental concerns, many regulations are being developed to prohibit the inefficient and smog producing practice of all-night idling, leading the trucking industry to seek cost efficient systems to provide off-period heat and air conditioning in the sleeper compartment. The market is attempting to answer this need. The following systems have been developed or patented for that purpose.

Battery-Powered Heaters are common in the art today, as disclosed in U.S. Pat. Nos. 5,497,941, 5,884,007, 6,040,561, 7,007,856, 7,380,586, 7,410,415, 7,707,845 and 7,870,892. In these systems, a vehicle's battery is the power source for a heating system to maintain a minimum temperature in a truck cabin. The battery provides power for a hearing element and fan, along with the control circuitry. The struggle with these systems is that, if operated for prolonged periods of time, they can drain the battery and leave the vehicle unable to start.

Engine-Based Systems are also common, as discussed in U.S. Pat. Nos. 5,571,432, and 6,237,357. These systems require the vehicle motor to provide power or heat, which is then distributed. The obvious down side to these systems is that they are highly inefficient, because the vehicle engine (typically 400 to 500 horsepower diesel motors) must be running during all non-driving periods. There are also systems, which use another small diesel motor to heat the antifreeze and turn a secondary air conditioning compressor. These systems add another engine to maintain cabin temperature. These motors burn about a gallon of diesel every four hours, which will cost around $10.00 per day (assuming $4.00 per gallon of diesel and 2.5 gallons of diesel per 10-hour off-period). These systems work but do not provide sufficient heat in comparison with traditional large motor units and unnecessarily duplicate the entire heating and cooling systems of a stock trucks sleeper compartment.

Auxiliary Generator Systems are the third method identified, as discussed in U.S. Pat. Nos. 4,762,170, 4,825,663, and 6,232,679, in which a small generator provides power to heaters and other devices within a cabin while the main engine is not running. This approach eliminates the wasteful idling of the main engine-based systems, as well as the dead battery that can result from battery-based heating systems. These auxiliary generator-based systems are complicated and prone to failure and require a second diesel engine, which must be maintained and requires diesel fuel to operate. These systems use around $10.00 per day of diesel fuel also.

Other Solutions include battery-operated Heat Pumps. These 120 Vac units require a power inverter to convert the vehicle's 12 Vdc power to 120 Vac, which can lose more than 10% of its delivered power during conversion. The blower fan is directed through the hot or cold side of the ‘box’ to circulate hot or cold air. They too work but do not provide the kind of heat that the diesel motor can deliver.

These systems show that vehicle cabin temperature control is an ongoing challenge that has had multiple solutions presented, and each has its own benefits and costs. What the industry needs is a system that can provide heat and air conditioning for the sleeper compartment when the vehicle motor is off, but does not drain the vehicle's primary battery pack and thus endanger the operator's ability to start the vehicle in the morning.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### BRIEF SUMMARY OF THE INVENTION

The invention disclosed is a Battery-Operated Auxiliary Power Unit that provides supplementary temperature control of a vehicle cabin. The invention allows a commercial truck driver to control the temperature of the truck's sleeper compartment during the off-period without running the truck motor and creating needless pollution.

The APU 11 comprises: Batteries 103 configured in an Auxiliary Battery Pack (ABP) 131 installed in Battery Box 135, Heating Element Assembly 109, Circulation Pump 107, Temperature Sending Unit 111, Filler Neck 113, Stock Compressor 115, Drive Motor 105, optional Electric Condenser 117, Evaporator 119, Heater Core 125, optional Alternator 121 to charge the ABP 131, the truck's standard battery pack, and optional Mineral Oil 140 as the heating fluid.

### BRIEF DESCRIPTION OF THE SEVERAL VIEWS OF THE DRAWING(S)

FIG. 1 is a block diagram of the invention. Items in dotted lines indicate components that are standard equipment on modern trucks.

FIG. 2 is a top view of the ABP 131 installed in the Battery Box 135.

### DETAILED DESCRIPTION OF THE INVENTION

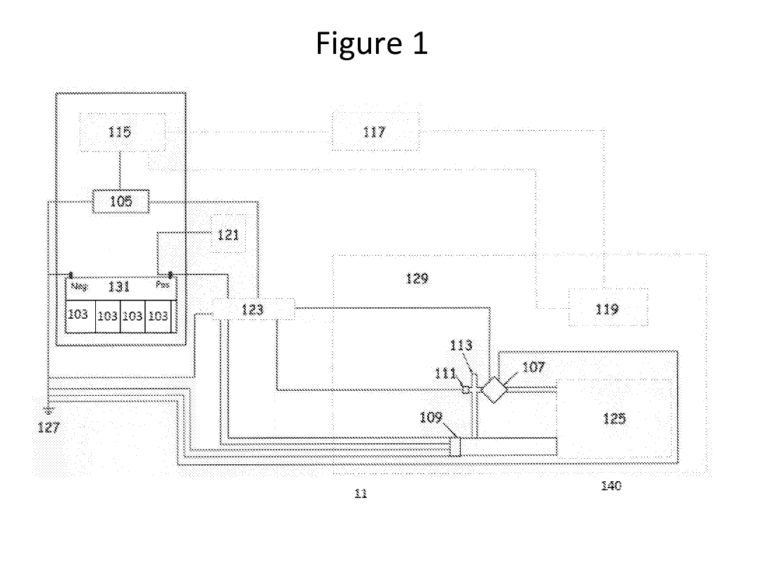

As represented in FIG. 1, the Battery-Operated Auxiliary Power Unit (“APU”) 11 provides supplementary temperature control of a vehicle cabin using an additional independent air conditioning and heating system, The system is powered by an auxiliary battery pack (ABP 131) at night without placing a load on the regular truck batteries, but is sufficiently charged by an alternator while the operator is driving during a normal shift.

The APU 11 comprises: Batteries 103 configured in an Auxiliary Battery Pack (ABP) 131 and installed in Battery Box 135, Heating Element Assembly 109, Circulation Pump 107, Temperature Sending Unit 111, Filler Neck 113, Stock Compressor 115, Drive Motor 105, optional Electric Compressor 117, optional Alternator 121 to charge the ABP 131, and optional Mineral Oil 140 as the heating fluid.

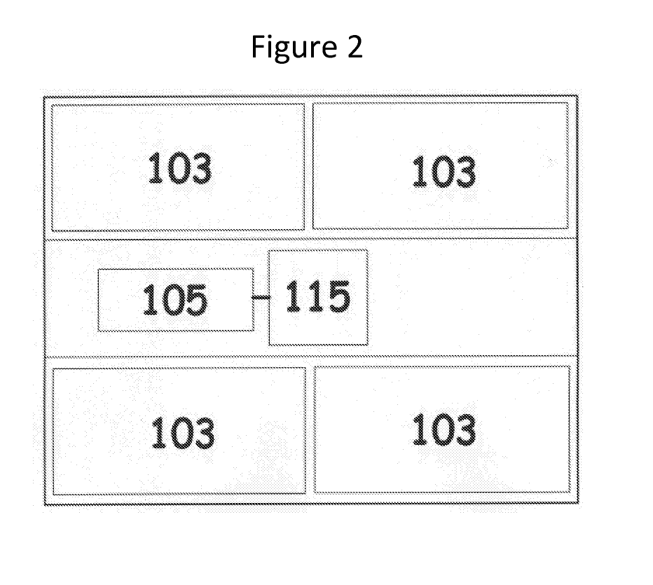

The ABP 131 is a battery pack that can be configured any number of ways, but as currently designed, the ABP 131 comprises four deep-cycle Batteries 103 connected in parallel to provide a 12V, 1000 A-hr, ten-hour power source. The ABP 131 is installed in a frame-mounted Battery Box 135, as shown in FIG. 2.

The Battery Box 135 is mounted between the frame rails behind the sleeper cabin and in front of the fifth-wheel trailer hitch. All semi trucks have this space available with no other equipment mounted in this location. The current design places half the batteries on each side of the ABP 13, leaving the center section of the box open for installation of other equipment, such as a relocated A/C Stock Compressor 115 and Drive Motor 105, or a completely new Electric Compressor 117.

As previously discussed, the truck's stock four batteries will remain in use and are not part of the APU 11. These truck batteries require a 130-amp alternator to keep them property charged. Federal law prohibits commercial operators from driving longer than eleven hours of a 14-hour period, so with the four additional batteries comprising the ABP 131, the truck's alternator must be able to fully charge all eight batteries while the truck is running down the road in an eleven-hour driving period, such that the ABP 131 has sufficient power to supply the heating/AC system, and any other electronic devices during the off-period. In practice, the inventor has determined that the system will function well when the Alternator 121 can provide 250 A of charging current to the two sets of battery packs. However, this replacement may not be necessary, depending upon the ambient temperature where the truck is operating and other conditions.

This APU will not replace the truck's front cabin heater. The front cabin heater will still provide front cabin heat and windshield defrosting functions. These two functions will only be required while the truck is driving down the road, so the APU 11 will not need to interfere with this bullet-proof system.

The APU 11 includes Heating Element Assembly 109 and the magnetic-driven impeller Circulation Pump 107 for sleeper cabin heating. The Heating Element Assembly 109, as currently designed, uses two 20 W heating elements, and is mounted inside the heating fluid reservoir which is plumbed directly into the heater core and in line with the circulation pump. This entire assembly is mounted in a housing with the attached blower fan, which is connected to the sleeper compartments ductwork. This assembly is typically located under the bed, inside the sleeper compartment and is not connected to the trucks drive motor cooling system.

In operation, the Heating Element Assembly 109 and magnetic-driven impeller Circulation Pump 107 are mounted in this housing to distribute heated mineral oil through the heater core. The stock blower fan is also mounted to the top of this housing, which circulates the hot air from inside the housing throughout the sleeper compartment via stock truck ductwork and this in turn heats the sleeper compartment. The new system continues to use the stock housing, heater core, ductwork and blower fan. The 12 V pump is rated continuous duty and uses magnetic power to turn the impeller. The impeller is not connected but floats freely in the pump casing. This means no leaking through a seal since there is no driveshaft connecting the pump motor and the impeller.

As shown in FIG. 3, the Heating Element Assembly is controlled as follows:
a) A user activates the heating operation through the use of the truck's stock temperature controller, which energizes the Heating Element Assembly 109, consisting of two 20 W resistive heating elements (both are energized to bring system to operating temperature and only one element is required to maintain operating temperature), and the Circulation Pump 107. The Pump 107 continuously circulates the heating fluid while the heating system operates.
b) The Temperature Sending Unit 111 provides a temperature reading for the truck's stock temperature controller, which deactivates the second heating element through the use of a solenoid (normally open switch) when the Mineral Oil 140 (or whatever heating fluid is employed in the system) reaches a preset maximum setting. The solenoid changes state again (closing the switch) to reenergize the second heating element if the temperature of the Oil 140 lowers to the preset minimum setting.
c) Throughout the heating cycle, the Circulation Pump 107 circulates the heated oil through the stock heater core and the oil reservoir (which houses the dual heating elements).
d) The user ceases operation through the use of the truck's built-in temperature controller, thus de-energizing the Pump 107 and Heating Element Assembly 109.

Typical vehicle heating systems circulate water or an antifreeze through a heater core, but this invention optionally uses Mineral Oil 140 instead of antifreeze, because it has a higher boiling point than antifreeze or water and is noncorrosive. The Mineral Oil 140 circulates through the heater core with the use of the Circulation Pump 107. The Mineral Oil 140 is added to the system through Filler Neck 113, and circulated through the heater core and is heated with the Heating Element Assembly 109 (instead of the diesel engine) and pumped through the heater core and copper piping which houses the Heating Element Assembly 109 and Circulation Pump 107. This entire heating system is mounted inside the truck's standard housing (typically mounted under the bed) and is not connected in any way to the diesel engine's cooling system.

The air conditioning system is an optional element of the APU 11. Though the discussion assumes that the Stock Compressor 115 is moved from the engine compartment to the Battery Box 135 and powered by a Drive Motor 105, the invention includes multiple configurations. The air conditioning function of the APU 11 can provide air conditioning for the front cabin and the sleeper compartment. The invention could be a retro-fit to a stock truck, or could be a manufacturer option. The invention can be installed and configured in at least two different ways, including:

a) Two Compressor Option—two different A/C compressors, the engine-connected Stock Compressor 115 and a separate 12V Electric Motor Driven Compressor 117 installed in the Battery Box 135 driven by the ABP 131; or

b) Relocation Option—the single stock A/C Stock Compressor 115 moved to the ABP Battery Box 135 and driven by a Drive Motor 105.

The preferred approach is to relocate the Stock Compressor 115 from the diesel engine where it is typically belt-driven in the engine compartment under the hood of the truck, to the center section of the Battery Box 135 and driven by a 12V electric Drive Motor 105. The same housing which holds the stock heater core and blower fan also hold the truck's stock evaporator core for air conditioning the sleeper compartment.

In operation, a user controls the A/C portion of the system (through the use of the truck's temperature controller unit), which energizes the 12V electric Drive Motor 107, which turns the A/C compressor 115 to increase the pressure of the refrigerant. The only unique part of this system is the use of the Drive Motor 107 to operate the compressor. As in most traditional A/C systems, when the refrigerant enters the evaporator the tubing size is increased which causes a rapid cooling of the refrigerant and the evaporator core as well. The sleeper compartment air is circulated through the housing (via the use of the blower fan and ductwork) where cold air is created and thus cools the sleeper compartment.

While this invention has been described as it is currently built, the invention is not limited to the disclosed embodiments, but can be employed in various equivalent arrangements included within the spirit and scope of the claims.

1) A Battery-Operated Auxiliary Power Unit, comprising:
a. an automotive vehicle equipped with a stock heating and air conditioning system for a sleeper compartment, comprising a temperature controller, heating fluid, a heater core, a condenser unit, and a battery;
b. an Auxiliary Battery Pack (ABP) which provides dc power to the invention's components that are not powered by the vehicle's stock battery;
c. a Heating Element Assembly, which includes two resistive heating elements, with separate electrical connections so that one element can be powered at a time, the elements mounted inside a fluid reservoir, which is plumbed to the heater core of the stock heating and air conditioning system;
d. a Circulation Pump, which circulates fluid traveling through the heater core and heating fluid reservoir while the heating system is in operation;
e. a Temperature Sending Unit which provides the temperature reading required for the truck's temperature controller to provide actuation and de-actuation of the heating elements, depending on the Heating Fluid temperature;
f. an Electric Air Conditioning Condenser.

2) A Battery-Operated Auxiliary Power Unit as in claim 1, with a non-standard 250 A Alternator which replaces a truck's stock alternator.

3) A Battery-Operated Auxiliary Power Unit as in claim 1 in which Mineral Oil is used as the heating fluid.

4) A Battery-Operated Auxiliary Power Unit as in claim 1 in which an enclosed Battery Box is mounted behind the sleeper compartment, and into which the Auxiliary Battery Pack and any other elements of the invention may be installed or relocated.

5) A Battery-Operated Auxiliary Power Unit as in claim 1 in which the truck's stock air conditioning compressor has been relocated to the Battery Box, and is driven by an Electric Motor.

6) A Battery-Operated Auxiliary Power Unit, comprising:
a. an automotive vehicle equipped with a stock heating and air conditioning system for a sleeper compartment, comprising a temperature controller, a heater core, a condenser unit, and a battery;
b. an enclosed Battery Box mounted between the rails of the vehicle behind the sleeper compartment;
c. an 1000 A-hr Auxiliary Battery Pack, installed in the Battery Box;
d. a 250 A Alternator, installed in place of a truck's stock alternator;
e. a Heating Element Assembly installed in the sleeper compartment, which includes two resistive 20 W heating elements mounted inside a fluid reservoir, each of the heating elements with separate electrical connections so that one or both elements can be energized, powered by the Auxiliary Battery Pack, and the reservoir plumbed to the heater core of the stock heating and air conditioning system;
f. a Circulation Pump, powered by the Auxiliary Battery Pack, which circulates Mineral Oil as a hearing fluid through the stock heater core and heating fluid reservoir while the heating system is in operation;
g. a Temperature Sending Unit which provides the temperature reading required for the truck's temperature controller to provide actuation and de-actuation of the heating elements, depending on the Heating Fluid temperature;
h. an Electric Air Conditioning Condenser, mounted in the Battery Box, powered by the Auxiliary Battery Pack, which replaces the stock air conditioner.

7) A Battery-Operated Auxiliary Power Unit, comprising:
a. an automotive vehicle equipped with a stock heating and air conditioning system for a sleeper compartment, comprising a temperature controller, a heater core, a condenser unit, and a battery;
b. an enclosed Battery Box mounted between the rails of the vehicle behind the sleeper compartment;
c. an 1000 A-hr Auxiliary Battery Pack, installed in the Battery Box;
d. a 250 A Alternator, installed in place of a truck's stock alternator;
e. a Heating Element Assembly installed in the sleeper compartment, which includes two resistive 20 W heating elements mounted inside a fluid reservoir, each of the heating elements with separate electrical connections so that one or both elements can be energized, powered by the Auxiliary Battery Pack, and the reservoir plumbed to the heater core of the stock heating and air conditioning system;
f. a Circulation Pump, powered by the Auxiliary Battery Pack, which circulates Mineral Oil as a hearing fluid through the stock heater core and heating fluid reservoir while the heating system is in operation;
g. a Temperature Sending Unit which provides the temperature reading required for the truck's temperature controller to provide actuation and de-actuation of the heating elements, depending on the Heating Fluid temperature;
h. a stock Air Conditioning Condenser, relocated from the engine compartment to the Battery Box, driven by an electric Motor Drive that is powered by the Auxiliary Battery Pack.

8) A Method for controlling the temperature of a truck that has a sleeper compartment and a stock air conditioning and heating system, comprising:
a. mounting an enclosed Battery Box between the rails of a truck behind the sleeper compartment;
b. installing a 1000 A-hr Auxiliary Battery Pack (ABP) into the Battery Box;
c. replacing the truck's stock alternator with a 250 A Alternator;
d. connecting the Alternator to the ABP so it is charged along with the truck's stock batteries;
e. installing a new Heating Element Assembly into the sleeper compartment, which includes one or more resistive heating elements mounted inside a Fluid Reservoir, each of the heating elements with separate electrical connections so that one or more elements can be energized while powered by the ABP,
f. plumbing the Fluid Reservoir and ABP-powered Circulation Pump to the heater core of the stock heating and air conditioning system in the sleeper compartment, so that the Circulation Pump circulates Mineral Oil as a hearing fluid through the stock heater core and heating fluid reservoir to heat the sleeper compartment while the heating system is in operation;
g. installing a Temperature Sending Unit in the sleeper compartment so it provides a temperature to a reading required for the truck's temperature controller to provide actuation and de-actuation of the heating elements, depending on the Heating Fluid temperature;
h. mounting an Electric Air Conditioning Condenser in the Battery Box, powered by the Auxiliary Battery Pack, and plumbing it so it replaces the stock air conditioner condenser;

9) Method as described in claim 8, steps a-g, and the additional steps as follows:
h. moving a truck's stock air conditioner condenser from the engine compartment to the Battery Box;
i. installing the stock condenser so that it drives the stock condenser;
j. mounting an electric Motor Drive in the Battery Box;
k. powering the Motor Drive from the ABP; and,
l. using the Motor Drive to provide rotary motion for the relocated stock condenser.
